(19) United States
(12) Patent Application Publication
(10) Pub. No.: US 2018/0340858 A1
(43) Pub. Date: Nov. 29, 2018

(54) Application of Ultrasonic Guided Waves for Structural Health Monitoring of Bonded Joints

(71) Applicant: The Boeing Company, Chicago, IL (US)

(72) Inventors: Mohammadreza Jahanbin, Mukilteo, WA (US); Jeong-Beom Ihn, Bellevue, WA (US)

(73) Assignee: The Boeing Company, Chicago, IL (US)

(21) Appl. No.: 15/602,871

(22) Filed: May 23, 2017

(51) Int. Cl. G01M 5/00; G01N 29/04; G05B 19/048

(52) U.S. Cl. CPC G01M 5/0066; G05B 2219/23445; G05B 19/048; G01N 29/043

(57) ABSTRACT

Systems and methods for structural health monitoring of adhesively bonded joints using guided waves. The method determines the quality of adhesive bonds between two materials by injecting a high-frequency (e.g., 5 MHz or higher) ultrasonic signal and measuring a characteristic of the ultrasonic waves which propagate through the adhesive, trapped and guided by the interfaces between the bonded materials and the adhesive. Prior to an inspection of an actual adhesively bonded structure, that structure is simulated using a finite element model. Also propagation of guided ultrasonic waves along the adhesive bondline is simulated to derive interface wave predicted properties. During ultrasonic inspection of the actual structure, interface wave measured properties are derived. The quality of the adhesive bondline is determined by comparing the empirical interface wave measured properties to simulated interface wave predicted properties.

### BACKGROUND

This disclosure generally relates to structural health monitoring of hybrid structures, and more particularly to systems and methods for structural health monitoring of adhesively bonded joints.

Bonded structures are used to create a load path between the surfaces of distinct structural elements. Adhesive bonding has a number of positive attributes that make it an attractive assembly method, particularly for structures made partially or completely out of composite materials.

Hybrid structures are those joints that are made of two sections with different material properties. Such joints are typically either co-bonded or co-cured in the manufacturing process. A typical hybrid structure has one section of metal with the other being a composite laminate.

It would be desirable to provide means and methods for monitoring the adhesive bond in a hybrid structure.

### SUMMARY

The systems and methods described herein provide a repeatable and reliable non-destructive technique for monitoring the structural health of an adhesive bond by comparing the inspected structure with a simulated undamaged structure and/or simulated damaged structures. The disclosed systems and method employ guided waves. Guided waves are acoustic waves that are guided by boundaries.

More specifically, the subject matter disclosed herein is directed to systems and methods for structural health monitoring of adhesively bonded joints using guided waves. The method determines the quality of adhesive bonds between two materials by injecting a high-frequency (e.g., 5 MHz or higher) ultrasonic signal and measuring a characteristic of the ultrasonic waves which propagate through the adhesive, trapped and guided by the interfaces between the bonded materials and the adhesive. Prior to an inspection of an actual adhesively bonded structure, that structure is simulated using a finite element model. Also propagation of guided ultrasonic waves along the adhesive bondline is simulated to derive interface wave predicted properties. During ultrasonic inspection of the actual structure, interface wave measured properties are derived. The quality of the adhesive bondline is determined by comparing the empirical interface wave measured properties to simulated interface wave predicted properties. In accordance with various embodiments, the properties of interest may include one or more of the following wave characteristics: time of travel (i.e., velocity), change in amplitude, change in phase and change in wave energy distribution (i.e., dissipation).

The systems and methods disclosed in some detail below use numerical simulation and modeling to study and visualize the behavior of ultrasonic wave propagation in isotropic, anisotropic, and hybrid media. The results of these modeling techniques can be of particular interest in the development of non-destructive evaluation techniques and the optimal placement of the ultrasonic wave generator and ultrasonic wave sensor in a structural health monitoring system. In accordance with some embodiments, the numerical simulation technique uses open-source Finite Element Analysis (FEA) code, Abaqus Dynamic Explicit, which has the capability to model different damage scenarios and failure modes in a variety of structures.

A structural health monitoring system that utilizes numerical simulation with finite element modeling can reduce the cost associated with calibration of fixed or portable non-destructive testing (NDT) tools and equipment in term of adjustments for frequency, range, transducer type, and placement. The system disclosed herein also can predict the expected results from inspection by simulating the behavior of ultrasonic wave propagation in metals and composite material, as well as the adverse effect of any flaw or damage in the structure. One benefit of this system is that the operator or inspector can use the simulation results and visualize the expected outcome of the inspection, before adjusting the tool and interrogating the structure for inspection. Finite element modeling can also be used for verification and justification of the inspection method and ultimately enables a change from a schedule-based maintenance concept to a condition-based maintenance approach.

The inspection methods disclosed in some detail below are based on the use of interface guided waves (hereinafter “interface waves”) to evaluate the damage at the bondline of hybrid structures. In particular, the disclosed inspection methods use interface waves for bonding assessment of hybrid structures and laminated composites. Interface waves pose good characteristics, such as large displacement and high energy, at the interfaces of two materials. These characteristics result in the interface waves exhibiting high sensitivity to interfacial damages of hybrid structures at selected modes and frequencies, compared to other ultrasonic waveforms, which typically propagate through the thicknesses of the media.

One aspect of the subject matter disclosed in detail below is a method for structural health monitoring of an adhesive bondline in a structure, comprising: (a) simulating a structure comprising first and second simulated substrates joined along a simulated adhesive bondline; (b) simulating propagation of ultrasonic waves along a portion of the simulated adhesive bondline; (c) storing reference data in a non-transitory tangible computer-readable storage medium, which reference data represents a wave characteristic of simulated ultrasonic waves that have propagated along the portion of the simulated adhesive bondline and arrived at a sensing location on a surface of the simulated structure; (d) generating ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondline respectively; (e) converting ultrasonic waves which have propagated along the portion of the adhesive bondline and arrived at a sensing location on a surface of the actual structure into measurement electrical signals; (f) processing the measurement electrical signals to derive measurement data representing an empirical wave characteristic; (g) storing the adhesive bondline data representing the empirical wave characteristic in the non-transitory tangible computer-readable storage medium; (h) determining a difference between the measurement data and the reference data; (i) classifying the adhesive bondline as being damaged or not in dependence on the difference; (j) generating a flag in response to the adhesive bondline being classified as damaged; and (k) repairing or replacing the damaged adhesive bondline. In one example scenario, the first substrate is a metallic substrate and the second substrate is a composite laminate.

In accordance with one embodiment, the simulated adhesive bond has no simulated defects, and classifying the adhesive bondline comprises classifying the adhesive bondline as being damaged if the difference is greater than a specified threshold. In accordance with another embodiment, the simulated adhesive bond has at least one simulated defect, and classifying the adhesive bondline comprises classifying the adhesive bondline as being damaged if the difference is less than a specified threshold.

The wave characteristics used to discriminate damage in the bondline may be one or more of the following parameters: time of travel, change in amplitude, change in phase, and change in wave energy distribution of the ultrasonic waves as the ultrasonic waves propagated along the portion of the adhesive bondline.

One advantage of combining numerical simulation with ultrasonic inspection is that a simulated setup that shows acceptable efficacy can be replicated for purposes of inspecting an actual structure. In particular, the generating location used to simulate inspection of the simulated structure and the generating location on the actual structure can be the same, and the sensing location used to simulate inspection of the simulated structure and the sensing location on the actual structure can be the same.

Another aspect of the subject matter disclosed in detail below is a method for structural health monitoring of an adhesive bondline, comprising: (a) simulating a structure comprising first and second simulated substrates joined along a simulated undamaged adhesive bondline free of defects; (b) simulating propagation of ultrasonic waves along a portion of the simulated undamaged adhesive bondline free of defects; (c) simulating respective structures comprising the first and second simulated substrates joined along respective simulated damaged adhesive bondlines having respective defects of different lengths, wherein the undamaged adhesive bondline and the damaged adhesive bondlines have the same material properties and the same thickness; (d) simulating propagation of ultrasonic waves along a portion of each simulated damaged adhesive bondline; (e) storing reference data in a non-transitory tangible computer-readable storage medium, which reference data represents wave characteristics of simulated ultrasonic waves that have propagated along the respective portions of the undamaged and simulated damaged adhesive bondlines and arrived at a sensing location on a surface of the simulated structure; (f) generating ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondlines respectively; (g) converting ultrasonic waves which have propagated along the portion of the adhesive bondline and arrived at a sensing location on a surface of the actual structure into measurement electrical signals; (h) processing the measurement electrical signals to derive measurement data representing an empirical wave characteristic; (i) storing the measurement data representing the empirical wave characteristic in the non-transitory tangible computer-readable storage medium; (j) comparing the measurement data to the reference data; (k) classifying the adhesive bondline as being damaged or not in dependence on the results of comparing the measurement data to the reference data; (I) generating a flag in response to the adhesive bondline being classified as damaged; and (m) repairing or replacing the damaged adhesive bondline.

A further aspect of the subject matter disclosed in detail below is a structural health monitoring system comprising: a wave generator, a pulser configured to send pulses to the wave generator, a wave sensor, a receiver configured to receive electrical signals from the wave sensor, and a computing system configured with simulation software, system control software for controlling the pulser and receiver, signal analysis software for analyzing signals output by the receiver, and a non-transitory tangible computer-readable storage medium. The simulation software is configured to enable the computing system to perform the following operations: simulating a structure comprising first and second simulated substrates joined along a simulated undamaged adhesive bondline free of defects; simulating propagation of ultrasonic waves along a portion of the simulated undamaged adhesive bondline free of defects; simulating respective structures comprising the first and second simulated substrates joined along respective simulated damaged adhesive bondlines having respective defects of different lengths, wherein the undamaged adhesive bondline and the damaged adhesive bondlines have the same material properties and the same thickness; simulating propagation of ultrasonic waves along a portion of each simulated damaged adhesive bondline; and storing reference data in the non-transitory tangible computer-readable storage medium, which reference data represents wave characteristics of simulated ultrasonic waves that have propagated along the respective portions of the undamaged and simulated damaged adhesive bondlines and arrived at a sensing location on a surface of the simulated structure. The system control software is configured to enable the computing system to perform the following operations: causing the wave generator to generate ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondlines respectively; and causing the wave sensor to convert ultrasonic waves which have propagated along the portion of the adhesive bondline and arrived at a sensing location on a surface of the actual structure into measurement electrical signals. The signal analysis software is configured to enable the computing system to perform the following operations: processing the measurement electrical signals to derive measurement data representing an empirical wave characteristic; and storing measurement data representing the empirical wave characteristic in the non-transitory tangible computer-readable storage medium. The system control software is further configured to enable the computing system to perform the following operations: comparing the measurement data to the reference data; classifying the adhesive bondline as being damaged or not in dependence on the results of comparing the measurement data to the reference data; and generating a flag in response to the adhesive bondline being classified as damaged. The empirical wave characteristic is selected from the following group: wave velocity, wavefront time of flight over a given distance, wave attenuation and wave energy dissipation.

Other aspects of methods for characterizing adhesively bonded joints in structures and predicting performance of adhesively bonded structures are disclosed below.

### BRIEF DESCRIPTION OF THE DRAWINGS

The features, functions and advantages discussed in the preceding section can be achieved independently in various embodiments or may be combined in yet other embodiments. Various embodiments will be hereinafter described with reference to drawings for the purpose of illustrating the above-described and other aspects.

FIG. 1 shows one embodiment of an adhesively bonded hybrid structure that can be simulated using the methods disclosed herein. In particular, the diagram shows an ultrasonic wave generator and an ultrasonic wave sensor placed on a surface of a composite laminate on opposite sides of an attached metallic substrate for the purpose of non-destructively inspecting the bondline.

FIG. 2 is a diagram representing an isometric view of a model (using the ABAQUS composite layup tool) of a composite section.

FIG. 3 is a graph showing a Hanning-windowed, five-cycle burst of a sinusoidal signal used as a pulse excitation signal at an ultrasonic signal generator.

FIG. 4 is a diagram representing the same side view of a hybrid structure depicted in FIG. 1 with the addition of a symbol indicating the location of a disbond between the metallic substrate and composite laminate.

FIG. 5 is a diagram representing an idealized perfectly bonded joint (i.e., no adhesive was assumed) between a metallic substrate and a composite laminate in which a delamination between the first and second plies of the composite laminate is offset from the bondline.

FIG. 6 is a diagram representing an idealized adhesively bonded joint between two substrates having respective coatings applied on respective prepared surfaces.

FIG. 7 is a diagram representing a side view of a hybrid structure comprising a composite laminate and a metallic substrate attached to the composite laminate by a layer of adhesive.

FIG. 8 is a diagram representing an idealized damaged adhesively bonded joint between two substrates having respective coatings applied on respective prepared surfaces and having a pair of free edge disbonds at respective coating-adhesive interfaces.

FIG. 9 is a diagram representing an idealized damaged adhesively bonded joint between two substrates having respective coatings applied on respective prepared surfaces and having a free edge crack in the adhesive.

FIG. 10 is a graph of time of flight versus adhesive density reduction for a traveling wave propagating from one point to another point in an adhesive bond.

FIG. 11 is a block diagram identifying some components of a structural health monitoring system in accordance with one embodiment.

FIG. 12 (consisting of FIGS. 12A and 12B) is a flowchart identifying steps of a method for non-destructive inspection of adhesively bonded joints in accordance with one embodiment.

FIG. 13 is a block diagram identifying components of a computer system suitable for executing automated data processing functions that simulate wave propagation along an adhesively bonded joint in a structure.

Reference will hereinafter be made to the drawings in which similar elements in different drawings bear the same reference numerals.

### DETAILED DESCRIPTION

For the purpose of illustration, systems and methods for structural health monitoring of hybrid structures made of a metal or metal alloy and composite material (e.g., a composite laminate made of fiber-reinforced plastic) that enable identification and quantification of bondline damage or degradation will now be described in detail. However, not all features of an actual implementation are described in this specification. A person skilled in the art will appreciate that in the development of any such embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

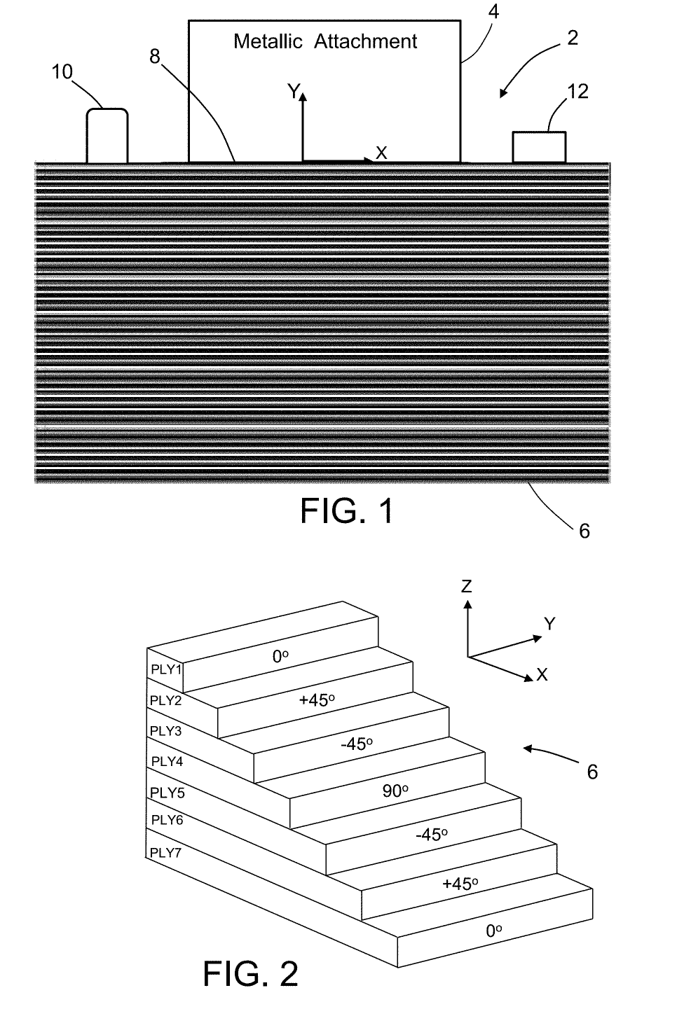

FIG. 1 shows one example configuration of an adhesively bonded hybrid structure 2 that can be simulated using the methods disclosed herein. The upper section of structure 2 is a metallic (e.g., aluminum) substrate 4. The lower section is a composite laminate 6 made of carbon fiber-reinforced plastic (CFRP). In this particular model, the metallic substrate 4 and composite laminate 6 are perfectly bonded (i.e., no adhesive was assumed) along a bondline 8. FIG. 1 also shows a wave generator 10 and a wave sensor 12 placed on a surface of the composite laminate 6 on opposite sides of the metallic substrate 4 for the purpose of non-destructively inspecting the bondline 8. The wave generator 10 and wave sensor 12 may each comprise a respective ultrasonic transducer. The composite laminate 6 comprises a stack of plies, each ply comprising a multiplicity of parallel fibers. The fibers in the respective plies have orientations selected from the following: 0, ±45, and 90 degrees. Still referring to FIG. 1, the interfacing bonded ply is called the inner mold line (IML) and the farthest ply from the bondline 8 is the outer mold line (OML). The ply orientation of the IML should be considered in the determination of interface wave speed at the bondline 8.

The configuration depicted in FIG. 1 replicates situations in which metallic fittings are attached to the composite structure in wing fabrication or in repair circumstances where a composite patch is used for metallic skin or a composite surface is repaired with a metallic patch. A model of a hybrid structure can also be used to investigate the bonding condition of two composite sections by changing the metallic section to another laminated or honeycomb composite. In some applications, to avoid corrosion between metals and CFRP, layers of different materials might be used at the interfaces, and for composite-composite hybrid interfaces, a layer of adhesive might be used; all of these configurations can be simulated by introducing a third material or viscous properties of adhesives.

FIG. 2 is a diagram representing an isometric view of a model (using the ABAQUS composite layup tool) of one example of a composite laminate 6. Each lamina in the composite laminate is a single ply with a ply thickness which is typically 0.2 mm. Typical fiber orientations are 0, ±45, and 90 degrees. In this example, the fibers in the first and seventh plies are oriented at 0 degrees, the fibers in the second and sixth plies are oriented at +45 degrees, the fibers in the third and fifth plies are oriented at −45 degrees, and the fibers in the fourth ply are oriented at +45 degrees,

One consideration for structural health monitoring is to examine the effect of the orientation of the first ply (i.e., the IML) of the composite laminate 6. The interface waves decay away from the bondline 8 so the orientation and thickness of other plies through the thickness of the composite laminate 6 are not of interest. However, typically, the second and third plies can play an important role in the interlaminar interactions of the composite laminate.

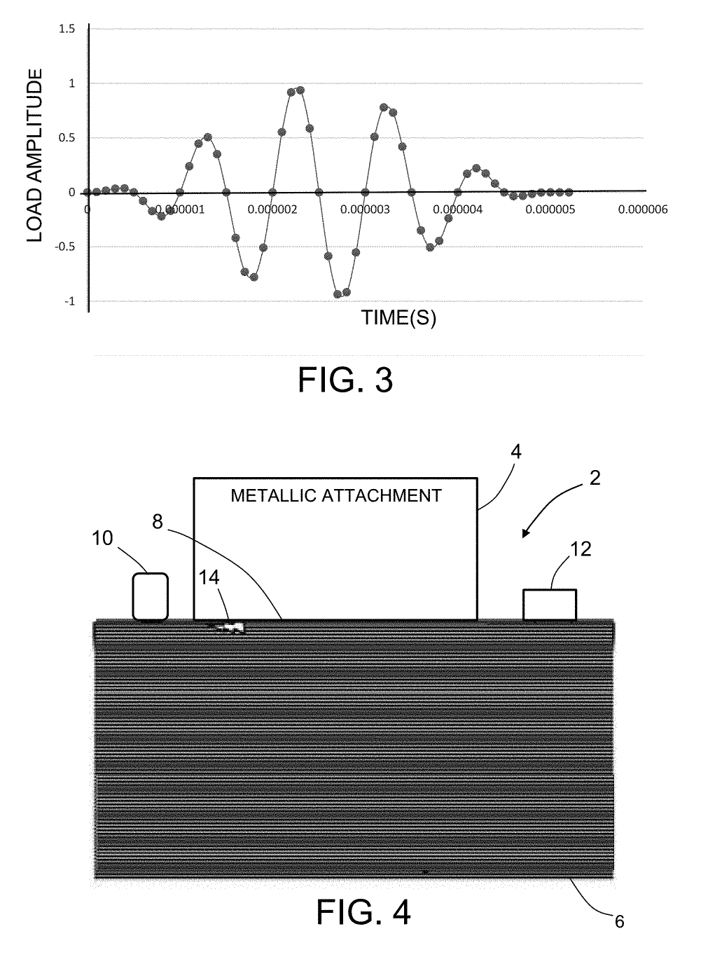

In one example, ABAQUS 6.14 was used for wave propagation analysis. Plane strain continuum shell elements were utilized. These elements include the effects of transverse shear deformation. The anisotropic section was built up by composite layup tools to form a balanced, symmetric laminate and all the unidirectional plies were meshed accordingly. A typical mesh had around 520,000 nodes and 520,000 linear quadrilateral, two-dimensional plane strain elements. The model was constrained for translation and rotation at the two upper corners of the metallic section and the two lower corners of the composite section. An excitation source or wave generator 10 was placed on the composite laminate 6 on one side of the bondline 8, and a receiving wave sensor 12 was placed on the composite laminate 6 on the other side of the bondline 8. A Hanning-windowed, five-cycle burst of a sinusoidal signal (shown in FIG. 3) was used as the pulse excitation signal. The initial forcing frequency was set at 1 MHz to model the interface wave. A 10-MHz excitation was also used to investigate the influence of frequency on damage identification.

Interface wave simulations can be used to detect bonding defects in hybrid structure joints. The velocity of the interface wave and the reflected waves provide information quantifying the simulated damage, e.g., size and location, by baselining the wave behavior with respect to the undamaged and undamaged condition of the simulated structure.

As used herein, the term “disbond” refers to separation of the bondline adhesive from either the metallic substrate or the IML (i.e., first ply) of the composite laminate. As used herein, the term “delamination” refers to either a single or multiple interply separation within the composite laminate. Delaminations can be caused by contaminations, lack of compaction during the production and cure phase, or by the impact of an overheating of the cured material. In the bonded joints, where the adhesion strength of the bond is high, delaminations can be located in close proximity to the bondline.

In accordance with one simulation, a disbond crack 14 was introduced at one free edge of the bondline 8 (see FIG. 4) and the resulting disruption in the continuity of interface wave propagation was monitored to calculate the delay in time of flight (the travel time of the interface wave) from the wave generator 10 to the wave sensor 12. An undamaged or perfectly bonded interface (i.e., no adhesive was assumed) as well as different lengths of disbond cracks were considered in this simulation. This simulation assumed that the crack nucleates in the interface between the metallic substrate 4 and composite laminate 6. Both the wave generator 10 and wave sensor 12 were placed on the exposed surface of the composite laminate 6. Several different crack sizes were considered ranging from 2.54 mm to 25.4 mm for a 101-mm bondline. Simulations were also performed for an undamaged (i.e., undamaged) structure to provide the baseline. The travel time of the propagating wave from the wave generator 10 to the wave sensor 12 was recorded.

The results of the above-described simulation were that as the size of the anomaly increased, the time of travel of the wave pulse increased. The interface wave was faster when the direction of wave propagation aligned with the composite ply direction (i.e., 0 degree), whereas a 90-degree ply orientation caused the slowing of the interface wave. A nominal 5% delay in time of flight was observed for recorded signals at the wave sensor 12 when the fiber orientation was perpendicular to the interface wave travel path on the bondline 8. For both cases, the interface wave speed appeared to vary linearly with the crack size.

Two additional simulations showed that the time of travel of the interface wave decreased as the frequency increased. In other words, the interface wave propagated faster at higher frequencies. For this simulation the increase in speed was about 4% (for an increase in frequency from 1 to 10 MHz). The time of flight linearly increased with the length of disbond crack size. This linear trend suggests that the broad frequency domain of interface waves can be used for structural health monitoring.

The above-described numerical modeling of ultrasonic interface waves propagating along the bondline of a hybrid isotropic/anisotropic structure demonstrated that the velocity of the interface wave is sensitive to the bondline health and can be used for monitoring the condition of complex bonded structures. The same numerical modeling was also used to evaluate the directional dependency of interface waves on the orientation of the fibers in the associated ply of the composite laminate. The results of the simulation indicated that interface waves propagate faster in perfectly bonded hybrid structures as well as parallel to the fiber direction of the composite ply. The pervasive effect of interface wave disruption can be quantified and used in the development of experimental test setups for wave generator-wave sensor placement in a pitch-catch ultrasonic structural health monitoring system.

In the simulations described above with reference to FIGS. 1 through 4, the disbond crack detection capability of simulated interface waves was demonstrated. The simulation results demonstrated how disconnection in the pathway of traveling wave or disbond crack size can be detected and measured by the change in parameters of the interface wave.

Additional numerical simulations were performed in an attempt to expand the same approach to a broad range of bonding problems. In reality the bonded load path is a chain of material and interfaces. The strength of the load path will be determined by the weakest link in this chain. This weak point is not usually the bondline in complex hybrid structures. Development and testing of bonded structures suggest different damage scenarios. In particular, simulations were run which enabled estimation of the interface wave parameters such as amplitude and wavelength that can produce effective waveforms for the guided waves to interrogate location and nature of anomaly in the bonded joints.

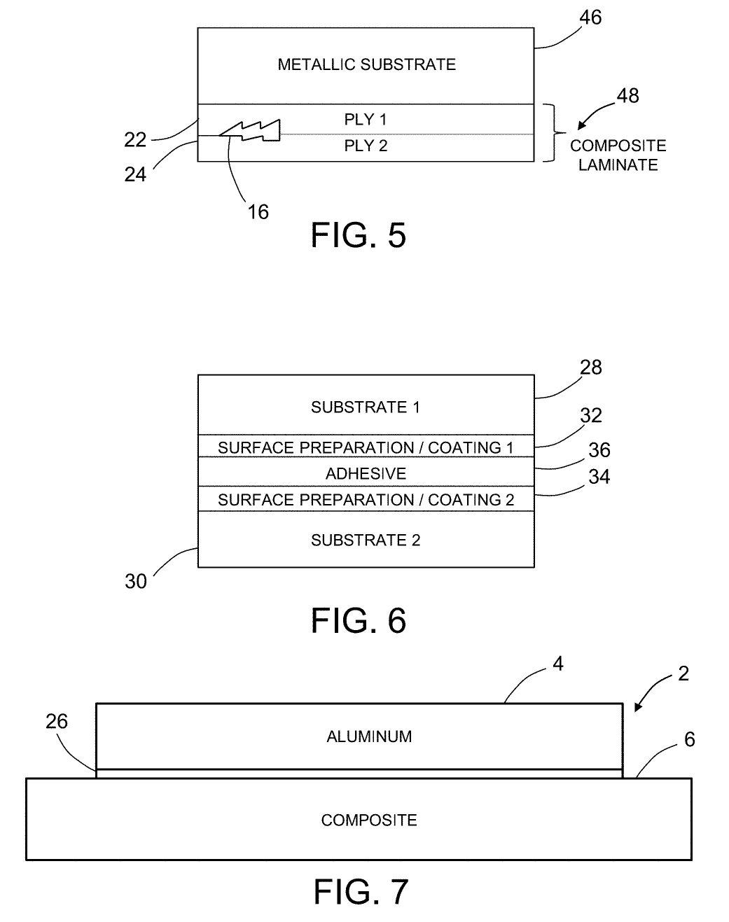

FIG. 5 is a diagram representing an idealized perfectly bonded (i.e., again no adhesive was assumed) joint between a simulated metallic substrate 46 and a simulated composite laminate 48. Only the first ply 22 and the second ply 24 of the simulated composite laminate 48 are shown. This simulated structure includes a delamination 16 in a region where the first and second plies 22 and 24 of the simulated composite laminate 48 have separated from each other. In this idealized example, the delamination 16 is offset from the bondline by the thicknesses of the first ply 22. In accordance with alternative models, a delamination located between the second and third plies (or other adjacent plies) of the simulated composite laminate 48 can be simulated.

Additional numerical simulations were conducted for the purpose of studying the capability of surface and interface waves for sub-surface delamination detection in the composite layers. The acoustic energy of surface and interface waves attenuates and the amplitude decays exponentially with depth into the composite layers. First, the penetration and effectiveness of the Rayleigh wave in isotropic and anisotropic media were calculated. The analytical study and simulation results showed that interface waves are sensitive for detecting near-boundary damages in the distances (e.g., depths) close to the bondline, relative to the wavelength of the propagating waves.

A finite element model of the type depicted in FIG. 1 was constructed for a bonded aluminum-composite hybrid structure of a type used in the aerospace industry. The simulation results (described in some detail hereinafter) demonstrated that a near-surface delamination in the composite laminate affects the time of flight or velocity of the interface wave at higher frequencies. Based on the material properties and fiber orientation of the composite laminate at the bondline, a frequency range spectrum for a usable interface wave, sensitive to near-surface defects, was calculated. The results shows that the time of flight increases as the size (length) of the delamination increases. Also the depth of the delamination layer affects the time of flight, within the range of the effective wavelength of the interface wave.

Typically in hybrid bonded joints, the strength of the co-bonded section with adhesive or co-cured section of composite laminate is higher than the bearing strength of the composite laminate. In these cases the bondline remains intact and intralaminar damage (e.g., fiber breakage and matrix cracking) or interlaminar damage (e.g., disbond and delamination) initiate at the first ply or between the first and second plies of the composite laminate. As described in some detail hereinafter, interface waves are effective for locating delaminations in hybrid bonded structures.

In hybrid structures, the wave propagation behavior is different on the two sides of the bondline due to different mechanical properties and wave velocity components. In the vicinity of damage, usually a wave mode conversion occurs with the scattering source at the center of damage. This scattering effect results in a changed wave energy distribution that eventually causes disruption in the propagation characteristics of traveling waves. (As used herein, the term “wave energy” represents a quantity that is proportional to the sum of the absolute value of the amplitude of the wave squared at particular sampled time points.)

Generally acoustic surface and interface waves are non-dispersive, particularly if the elastic half-space consists of a homogeneous material, hence the phase velocity does not depend on frequency or wavelength. However in the hybrid metallic-composite structure configuration, the modes corresponding to guided waves in an elastic multilayered half-space are usually dispersive. The dispersion curves of these guided waves can be used to infer the structural properties of the multilayered medium for the purpose of structural health monitoring (SHM). One SHM technique proposed herein uses time of flight (TOF) analysis for damage detection and assessment.

In finite element simulations involving delamination, a thick carbon fiber-reinforced plastic (FRP) composite section with laminate properties was bonded to an aluminum section on top, similar to the configuration seen in FIG. 1. The laminated CFRP composite in this hybrid structure was anisotropic and so, unlike the isotropic aluminum section, the fiber orientation caused a directional dependency of the mechanical properties. This composite section therefore also had corresponding directional dependency of wave velocity components. There are three velocities in composites, one longitudinal and two transverse, instead of two velocities in the aluminum section.

For a typical unidirectional composite laminate, the mechanical response and acoustic behavior of a propagating wave depend on the stacking sequence. As previously mentioned, the speed of wave propagation is sensitive to fiber orientation. In a further numerical simulation, this ply orientation dependency was investigated in further detail by examining surface and interface behavior for the laminated composite with 0-degree and 90-degree ply orientation on the surface and interface of the bonded section. The Rayleigh wave speeds propagating along the surface of our material system were determined.

For determining the effectiveness of surface and interface waves for detection of near surface and subsurface anomalies, the depth of penetration of the simulated waves into each section was verified. The wavelength of the ultrasonic wave had a significant effect on the probability of detecting a discontinuity. A general rule of thumb is that a discontinuity must be larger than one-half the wavelength to stand a reasonable chance of being detected.

The delamination numerical simulations were designed to study the behavior of a traveling interface wave along the bondline, when the size and location of delamination damage were varied. The changes in the wave amplitude, signal shape and delay in the arrival of the traveling wave along the bondline were compared with the case of an undamaged and perfectly bonded (i.e., no adhesive) baseline.

In the hybrid structure having a delamination which was constructed for FEM numerical simulation, a simulated composite laminate 48 had a simulated metallic substrate 46 attached on top as depicted in FIG. 5. More specifically, the simulation assumed that the simulated metallic substrate 46 was made of aluminum alloy 6061. The bearing strength of aluminum might be higher or lower than the composite material, depending on the ply orientation and direction of fibers in the composite material. The simulated hybrid structure also had a joint bonded by epoxy or adhesive that might possess higher strength compared to both the composite material and the aluminum. The failure mechanism and delamination nucleation typically starts from the weakest link of this joint, which is typically for a delamination between the top plies close to the bondline. Hence the modeling approach was based on the composition and mechanical properties of the composite laminate, to generate an effective waveform to interrogate the susceptible depth for delamination.

Multiple numerical simulations were performed simulating different damage scenarios when the delamination is located at several distances (i.e., offsets) from the bondline (i.e., at different depths in the composite laminate). Also in order to investigate the effect of separation size, the delamination damage simulations modeled delamination defects of different lengths. Traveling waves having respective frequencies of 1 and 5 MHz were simulated.

A time-of-flight assessment for the delamination simulations was extracted from modeling with various sizes at different locations (i.e., offsets from the bondline). The results showed that the time of flight was sensitive to size and location of the delamination. The interface wave formed at the bondline undergoes distortion and mode conversion in the area between the hybrid structure bondline and the delamination. The delay in time of flight in the delamination detection assessment was not as dramatic as in the previously described disbond crack detection assessment, in which it was shown that the time of flight increased linearly with increase in the size of the disbond crack. Similarly for delamination, the time of flight for all the scenarios with anomalies increased compared to the undamaged model or perfectly bonded hybrid joint. The range of detectability depended on the frequency of the propagating wave. The percent of average increase in time of flight was about 1.5% for delaminations in larger sizes within the effective range of frequency.

The preceding paragraphs summarize the results of disbond and delamination damage simulations assuming no adhesive at the bondline. The premise of a further numerical simulation was to demonstrate the application of ultrasonic interface guided waves for the inspection of adhesively bonded joints. In these simulations, a thin adhesive layer formed a bondline between the surfaces of distinct structural elements. Numerical simulations were performed which demonstrated that ultrasonic interface waves can be used for health monitoring of adhesive bonds. Interface waves are extremely sensitive to changes in density and viscosity of the adhesive layer. Using numerical and finite element simulations, it was observed that changes in propagation of the waveform, attenuation of leaky interface waves and time of flight are functions of adhesion quality. The results showed that interface waves can be used to inspect adhesively bonded joints and to determine the strength of the bondline. In connection with the manufacture and maintenance of aircraft made with composite materials, a guided wave mode can be used to monitor the structural integrity of composite laminates and adhesively bonded joints in an in-situ manner and throughout the service life of the aircraft.

FIG. 6 is a diagram representing an idealized adhesively bonded joint between a first simulated substrate 28 (e.g., a plate made of a metallic alloy) and a second simulated substrate 30 (e.g., a CFRP composite laminate). The adhesively bonded joint comprises a first simulated coating 32 applied on a prepared surface of the first simulated substrate 28, a second simulated coating 34 applied on a prepared surface of the second simulated substrate 30, and a layer of simulated adhesive 36 which occupies the space between and is adhered to the first and second simulated coatings 32 and 34.

The bonded load path is a chain of material and interfaces that form the adhesive bonded joint. The strength of the bond is determined by the weakest link in this chain. The interface wave frequency of this application can be optimized to the efficient wavelength to cover the entire chain of the bondline such that it can capture any adhesive or cohesive degradation of the elements shown in FIG. 6. Additional simulations were run to understand the interface wave effects produced by an anomaly in either of the two interfaces between substrates and coatings or in either of the two interfaces between the coatings and the adhesive. Numerical simulations were performed using the Explicit Dynamic solver of the ABAQUS Finite Element code to predict the existence of interface waves and to define their propagation characteristics based on the mechanical properties of the bonded joint and adhesive layer. Interface wave propagation was simulated in the interface between the first and second simulated substrates 28 and 30.

For the purpose of simulating the performance of an adhesively bonded joint, the first simulated substrate 28 seen in FIG. 6 was modeled to be a composite laminate 6 made of CFRP (shown in FIG. 7), the second simulated substrate 30 seen in FIG. 6 was modeled to be a metallic substrate 4 made of aluminum alloy 6061 (shown in FIG. 7), and the simulated adhesive 36 seen in FIG. 6 was modeled to be HYSOL EA-9394 adhesive 26 (shown in FIG. 7). (To avoid clutter, the coatings applied on the surfaces of the metallic substrate 4 and composite laminate 6 are not shown in FIG. 7). The simulated adhesive bondline of the simulated structure and the adhesive bondline of the actual structure had the same thickness.

The simulated adhesive 36 used in the model depicted in FIG. 6 matched with the low-viscosity HYSOL EA-9394 adhesive 26 (see FIG. 7) used for an experimental validation. HYSOL EA-9394 adhesive is an amine-cured epoxy paste adhesive which can be cured at room temperature. The adhesive has a density of 1.38 g/cc and a porosity of about 6%, which makes it suitable for post-peel ply application to CFRP composites. HYSOL EA-9394 adhesive has a glass transition temperature of 82° C. and a coefficient of thermal expansion of approximately 60×10⁻⁶° C.⁻¹ (between −30° C. and 70° C.).

Theoretical studies suggest that the interface waves propagate with speeds lower than the lowest speeds of bulk waves in the denser media. The finite element simulations of the performance of adhesively bonded joints showed that the velocities of the guided waves depend on the frequency of excitation, material orientation, and specific material properties at the interface boundary. The properties and quality of the adhesive layer can change the velocity of the interface wave. In the previously described delamination simulation, the approximate velocity of the interface wave for a similar configuration was 3 mm/sec, assuming a perfect bond without adhesive. The velocity of the interface wave increased due to the presence of the adhesive layer and was a function of the substrate-coating interfaces and the density, viscosity and elasticity of the adhesive layer.

In the numerical simulation of the adhesively bonded joint depicted in FIG. 7, the reaction of the interface waves to the changes in the bond material and in the interfaces of the adhesively bonded joint was investigated. Previously it was shown that the velocity of interface waves decreased as the size of disbond cracks and delaminations at the bondline increased. In the numerical simulation of the adhesively bonded joint depicted in FIG. 7, the focus was on interface degradation that depends on the bonding process. Therefore the changes in all elements of the interface such as surface preparation materials, coating types and adhesive itself were analyzed to evaluate the detection characteristics of interface waves. The results demonstrated the cases in which interface waves are sensitive to bond defects and that waveform distortion can be used to monitor the structural health of a bondline. The density and viscosity changes of adhesive also interfere with the normal wave behavior. The study focused on these interfacial changes to characterize the adhesion failure and detect the possibility of bond failure. Some simulations showed the waveform attenuation in the vicinity of an adhesive layer with undamaged density and modulus properties; other simulations showed the attenuation of the same waveform when it encounters a low-viscosity adhesive with reduced stiffness.

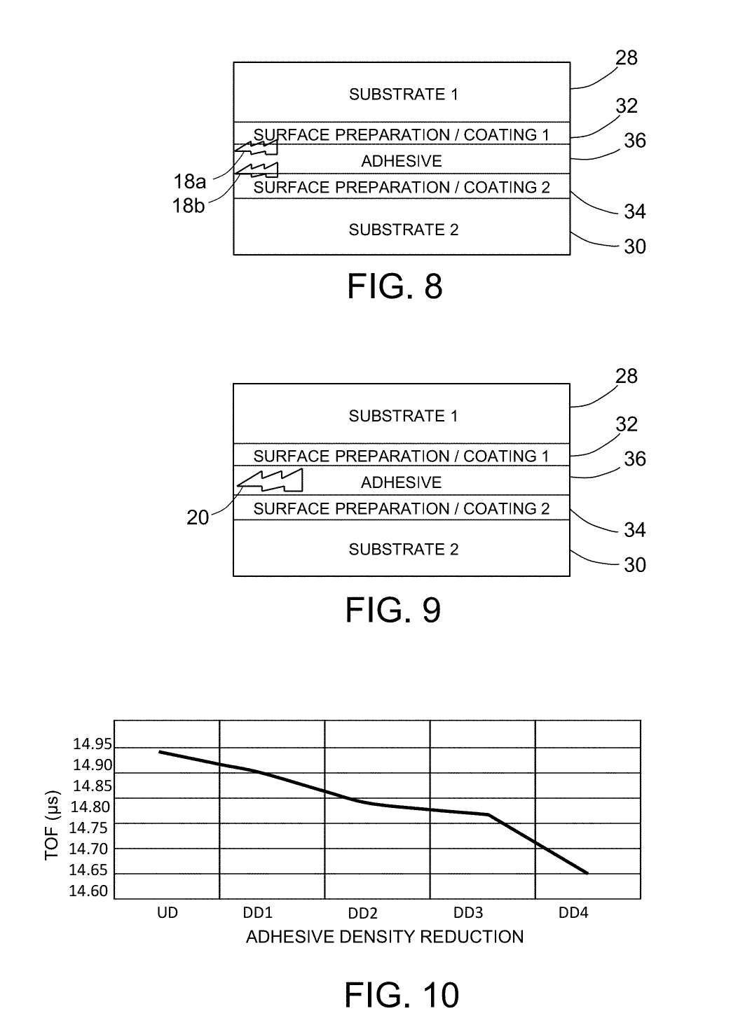

Another factor contributing to defects in adhesive bonds is reduced cohesion, which might happen separately, in conjunction with or in addition to reduced adhesion. FIG. 8 is a diagram representing an idealized damaged adhesively bonded joint between first and second simulated substrates 28 and 30 having respective simulated coatings 32 and 34 applied on respective prepared surfaces thereof. FIG. 10 shows areas where reduced cohesion may cause free edge disbonds 18a and 18b at the respective simulated coating-adhesive interfaces.

FIG. 9 is a diagram representing an idealized damaged adhesively bonded joint between first and second simulated substrates 28 and 30 having respective simulated coatings 32 and 34 applied on respective prepared surfaces thereof. FIG. 9 shows an area where reduced cohesion failure may cause a free edge crack 20 to form in the simulated adhesive 36.

In the following paragraphs, the results of numerical simulations for both adhesive and cohesive type of anomalies are discussed. The simulation results showed that the interface wave velocity (based on the time of flight between the same two points) increased with decrease in stiffness (density and viscosity) of the adhesive layer (constant thickness assumption). Some factors that contribute to the attenuation of interface wave in reduced-stiffness adhesive are absorption and scattering of the wave. In reality the pervasive effects of chemical and viscous effects are not linear, even though the numerical simulation represented a linear trend on interface wave propagation velocity.

In a homogeneous adhesive, neighboring particles move with different velocities and the viscoelastic force between them causes acoustic wave absorption. Table I shows the effect of changes in the density (UD=un-damaged) of the adhesive material on traveling wave propagation.

TABLE I

| | Density Change (g/cm³) | TOF (μsec) |
|---|---|---|
| UD | ρ = 1.38 | 14.89 |
| D1 | ρ = 0.70 | 14.85 |
| D2 | ρ = 0.35 | 14.79 |
| D3 | ρ = 0.17 | 14.77 |
| D4 | ρ = 0.09 | 14.65 |

FIG. 10 is a graph of the time of flight versus adhesive density reduction data listed in Table I. The phenomenon characterized by the data graphed in FIG. 10 is in good agreement with the general equation of wave velocity in solid media V∝(E/ρ)^{1/2} (E is the elastic constant of the adhesive and ρ is the density of the adhesive) in which the reduction in density is a contributing factor to increase in velocity of the propagating wave.

Another factor to characterize adhesive bond quality is the energy method and the measurement of the total energy dissipated per unit volume by viscous effects, i.e., the EVDDEN factor, which is an output in finite element analysis. The interface energy is confined to the region near the boundary. The energy method is more reliable compared to the time-of-flight measurement and attenuation. For instance, TOF monitoring is tedious and needs very accurate instrumentation for small-size test coupons. The measurement of attenuation might also not be preferred because it is difficult to consistently identify the attenuation due to leakage when there are other causes for loss of energy in the measurements.

Previous studies have found that the partition of the energy of the interface waves above and below the interface changes repeatedly with propagation distance due to interference between the two modes which have slightly different phase velocities. The energy density gradually decreases as adhesive viscosity decreases.

The pervasive effect of reduced cohesion on interface waves is similar to the studies on disbonds and delaminations (described above). The high-frequency interface wave is typically effective within the range of bonding construction which is less than one wavelength. So if there is a discontinuity in the pathway of the traveling wave, the wave behavior, such as the time of flight, changes and the effects change linearly with the size and location of the discontinuity.

The simulations showed that interface waves scatter due to a cohesive damage crack at the free edge of the bondline. In particular, disbond and delamination at the interface of the coating and the adhesive cause a Stoneley to Rayleigh wave mode conversion, where the lower boundary is structure and the upper boundary is vacuum due to crack. And also plate-like Lamb wave formation where the upper boundary is the bondline and upper boundary is delamination. Either case will change the slowness profile of the interface wave and reduction in waveform velocity.

The results of the above-described modeling techniques and damage simulations is of particular interest for the development of experimental test setups and the basic idea of wave generator-wave sensor placement for a pitch-catch ultrasonic structural health monitoring system, designed for laminated and hybrid structures.

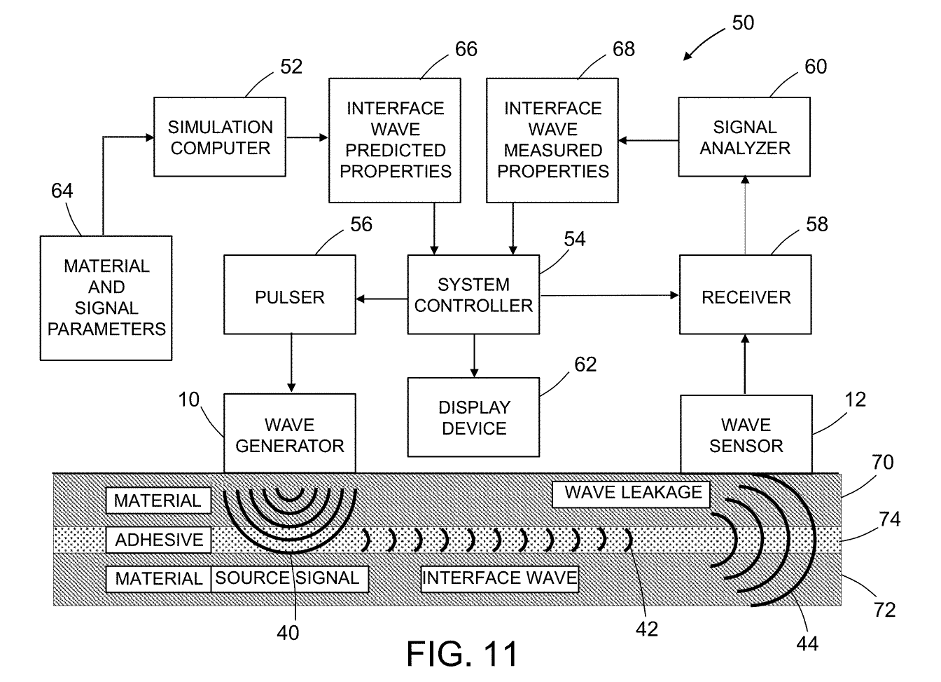

FIG. 11 is a block diagram identifying some components of a structural health monitoring system in accordance with one embodiment. In this particular configuration, there are at least three computer systems, namely, simulation computer 52, system controller 54 and signal analyzer 60. As used in the claims, the term “computing system” comprises one or more of the following: a computer, a processor, a controller, a central processing unit, a microcontroller, a reduced instruction set computer processor, an ASIC, a programmable logic circuit, an FPGA, a digital signal processor, and/or any other circuit or processing device capable of executing the functions described herein. For example, a computing system may comprise multiple microcontrollers or multiple processors which communicate via a network or bus. As used herein, the terms “computer” and “processor” both refer to devices having a processing unit (e.g., a central processing unit) and some form of memory (i.e., computer-readable medium) for storing a program which is readable by the processing unit.

As seen in FIG. 11, the simulation computer 52 is configured with material and signal parameters 64 for simulating interface wave propagation along an adhesively bonded joint. The results of such numerical simulations are interface wave predicted properties 66. The interface wave predicted properties 66 are transmitted in the form of digital reference data to the system controller 54, along with the signal parameters used in the simulation.

The system controller 54 is configured to send electrical control signals to a pulser 56, which electrical control signals instruct the pulser which pulsing scheme to employ. In response to those control signals, the pulser outputs electrical signals representing the ultrasonic waves to be generated to the wave generator 10. The wave generator 10 may comprise one or more ultrasonic transducer elements. The wave generator 10 transduces the electrical signals from pulser 56 into ultrasonic waves. More specifically, the electrical signals sent to the pulser 56 are configured to cause the pulser 56 to generate a burst of ultrasonic waves having wave characteristics which are the same or similar to the wave characteristics of the simulated ultrasonic waves used in the simulation. For example, the wave generator 10 may be excited using the Hanning-windowed, five-cycle burst of a sinusoidal signal depicted in FIG. 3.

The wave generator 10 is acoustically coupled to a surface of a first substrate 70 that is bonded to a second substrate 72 by a layer of adhesive 74. The wave generator 10 is activated to generate ultrasonic waves 40 that propagate through the material of the first substrate 70 and into the layer of adhesive 74. In accordance with some non-destructive inspection scenarios, the first substrate 70 is a metallic substrate and the second substrate 72 is a composite laminate. A portion of the wave energy entering the first substrate 70 becomes interface waves 42 which are guided by the substrate-adhesive interfaces to propagate in adhesive 74 along a line connecting the location of wave generator 10 to the location of wave sensor 12.

The wave sensor 12 is also acoustically coupled to the surface of the first substrate 70, but at a different location. The wave sensor 12 may comprise one or more ultrasonic transducer elements. The distance traveled by the interface wave 42 as it propagates from the wave generator 10 to the wave sensor 12 and the time of flight associated with that distance can be used to calculate the velocity of the interface wave 42, which velocity may vary in dependence of the state of health of adhesive 74. Some of the wave energy propagating along the adhesive 74 leaks out of the waveguide in the form of ultrasonic waves 44, which can be detected by the wave sensor 12.

The wave sensor 12 converts impinging ultrasonic waves into electrical signals which are sent to a receiver 58. The receiver 58 receives electrical signals from the system controller 54 representing the pulse burst transmitted by the wave generator 10. The receiver in turn outputs electrical signals representing the acquired ultrasonic inspection data to the signal analyzer 60.

The signal analyzer 60 is a computer system configured to analyze the acquired ultrasonic inspection data and calculate interface wave measured properties 68. The interface wave measured properties 68 preferably comprise one or more of the following wave characteristics of the ultrasonic waves that propagate from wave generator 10 to wave sensor 12: time of travel, change in amplitude, change in phase and change in wave energy distribution. The interface wave measured properties 68 are transmitted in the form of digital measurement data to the system controller 54. The system controller 54 is further configured to: (1) compare the measurement data (i.e., interface wave measured properties) to the reference data (i.e., interface wave predicted properties); (2) classify the adhesive 26 as being damaged or not in dependence on the results of comparing the measurement data to the reference data; and (3) generate a flag in response to the adhesive 26 being classified as damaged. The flag may be any one of the following: an analog signal, a digital code, a report, a notice, an alert or a warning. The flag may be displayed on a display device 62. In the alternative, the flag may take the form of an aural alert.

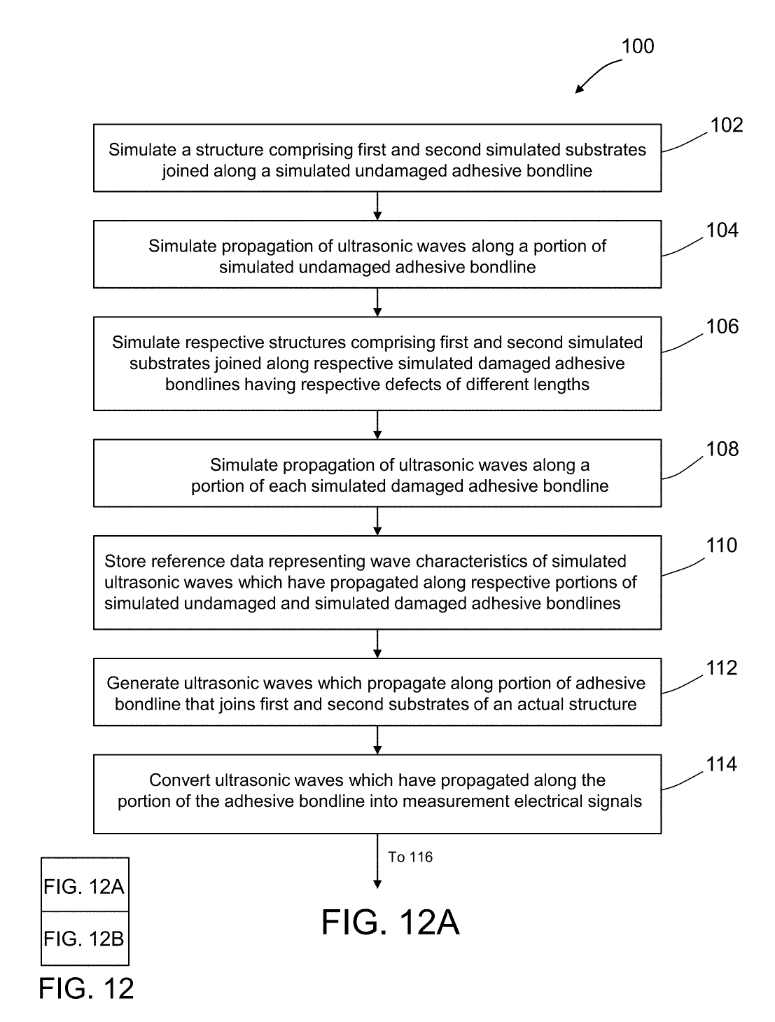

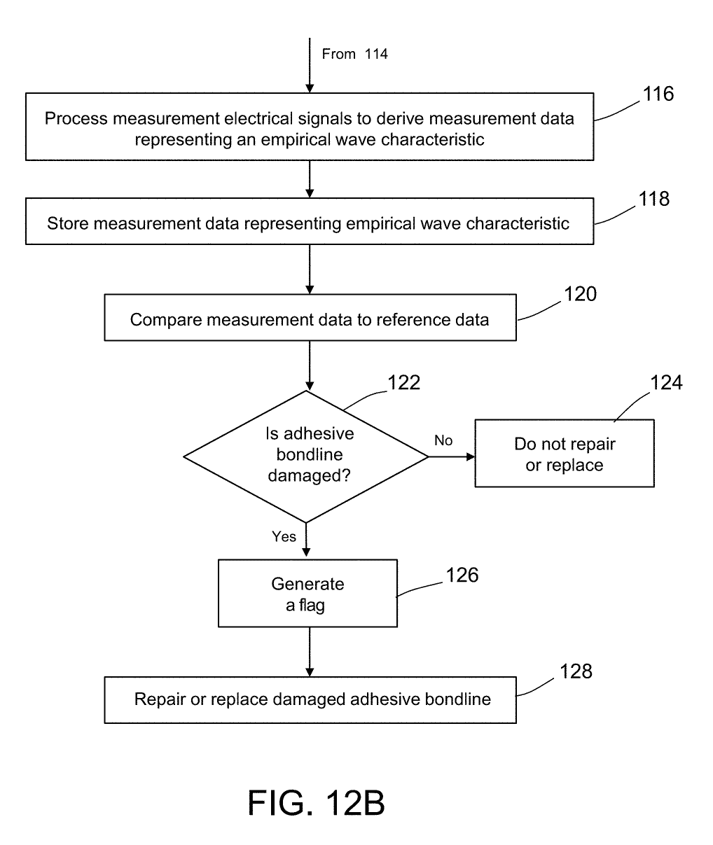

FIG. 12 (consisting of FIGS. 12A and 12B) is a flowchart identifying steps of a method 100 for structural health monitoring of adhesively bonded joints in accordance with one embodiment. Referring to FIG. 12A, the method 100 comprises the following steps: (a) simulating a structure comprising first and second simulated substrates joined along a simulated undamaged adhesive bondline free of defects (step 102 in FIG. 12A); (b) simulating propagation of ultrasonic waves along a portion of the simulated undamaged adhesive bondline free of defects (step 104); (c) simulating respective structures comprising the first and second simulated substrates joined along respective simulated damaged adhesive bondlines having respective defects of different lengths, wherein the undamaged adhesive bondline and the damaged adhesive bondlines have the same material properties and the same thickness (step 106); (d) simulating propagation of ultrasonic waves along a portion of each simulated damaged adhesive bondline (step 108); (e) storing reference data in a non-transitory tangible computer-readable storage medium, which reference data represents wave characteristics of simulated ultrasonic waves that have propagated along the respective portions of the undamaged and simulated damaged adhesive bondlines and arrived at a sensing location on a surface of the simulated structure (step 110); (f) generating ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondlines respectively (step 112); and (g) converting ultrasonic waves which have propagated along the portion of the adhesive bondline and arrived at a sensing location on a surface of the actual structure into measurement electrical signals (step 114).

Referring to FIG. 12B, the method further comprises: (h) processing the measurement electrical signals to derive measurement data representing an empirical wave characteristic (step 116); (i) storing measurement data representing the empirical wave characteristic in the non-transitory tangible computer-readable storage medium (step 118); (j) comparing the measurement data to the reference data (step 120); and/or (k) classifying the adhesive bondline as being damaged or not in dependence on the results of comparing the measurement data to the reference data (step 122). If a determination is made in step 122 that the adhesive bondline is not damaged, then the adhesive bondline is neither repaired nor replaced (step 124). If a determination is made in step 122 that the adhesive bondline is damaged, then a flag is generated (step 126) and then the damaged adhesive bondline is either repaired or replaced (step 128).

In accordance with an alternative embodiment, the method for ultrasonic inspection of an adhesive bondline in a structure comprises: (a) simulating a structure comprising first and second simulated substrates joined along a simulated adhesive bondline; (b) simulating propagation of ultrasonic waves along a portion of the simulated adhesive bondline; (c) storing reference data in a non-transitory tangible computer-readable storage medium, which reference data represents a wave characteristic of simulated ultrasonic waves that have propagated along the portion of the simulated adhesive bondline and arrived at a sensing location on a surface of the simulated structure; (d) generating ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondline respectively; (e) converting ultrasonic waves which have propagated along the portion of the adhesive bondline and arrived at a sensing location on a surface of the actual structure into measurement electrical signals; (f) processing the measurement electrical signals to derive measurement data representing an empirical wave characteristic; (g) storing measurement data representing the empirical wave characteristic in the non-transitory tangible computer-readable storage medium; (h) determining a difference between the measurement data and the reference data; (i) classifying the adhesive bondline as being damaged or not in dependence on the difference; (j) generating a flag in response to the adhesive bondline being classified as damaged; and (k) repairing or replacing the damaged adhesive bondline.

In accordance with one implementation of the method described in the preceding paragraph, the simulated adhesive bond has no simulated defects, and classifying the adhesive bondline comprises classifying the adhesive bondline as being damaged if the difference is greater than a specified threshold. In accordance with another implementation of the method described in the preceding paragraph, the simulated adhesive bond has at least one simulated defect, and classifying the adhesive bondline comprises classifying the adhesive bondline as being damaged if the difference is less than a specified threshold.

In accordance with one embodiment, the numerical simulation uses the material properties and dimensions of a simulated structure that matches the structure to be inspected. For example, the simulated adhesive bondline of the simulated structure and the adhesive bondline of the actual structure have the same thickness. In addition, the generating location (i.e., the location of a simulated wave generator) on the surface of the simulated structure and the generating location (i.e., the location of wave generator 10) on the surface of the actual structure are the same. Likewise the sensing location (i.e., the location of a simulated wave sensor) on the surface of the simulated structure and the sensing location (i.e., the location of wave sensor 12) on the surface of the actual structure are the same.

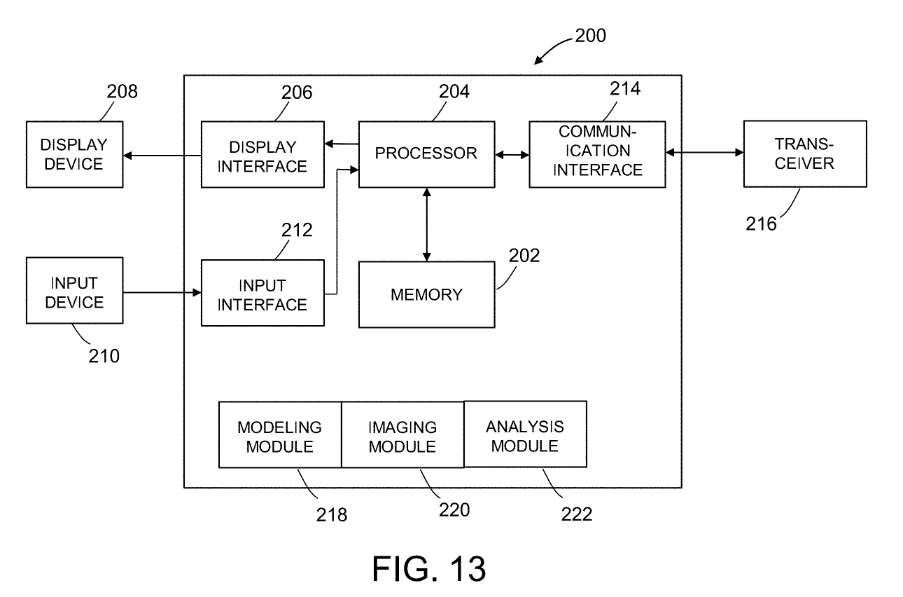

FIG. 13 is a block diagram identifying components of a computer system 200 suitable for executing automated data processing functions that simulate wave propagation along an adhesively bonded joint in a structure. In accordance with one embodiment, computer system 200 comprises a memory device 202 (e.g., a non-transitory tangible computer-readable storage medium) and a processor 204 coupled to memory device 202 for use in executing instructions. More specifically, computer system 200 is configurable to perform one or more operations described herein by programming memory device 202 and/or processor 204. For example, processor 204 may be programmed by encoding an operation as one or more executable instructions and by providing the executable instructions in memory device 202.

Processor 204 may include one or more processing units (e.g., in a multi-core configuration). As used herein, the term “processor” is not limited to integrated circuits referred to in the art as a computer, but rather broadly refers to a controller, a microcontroller, a microcomputer, a programmable logic controller, an application specific integrated circuit, and other programmable circuits.

In the exemplary embodiment, memory device 202 includes one or more devices (not shown) that enable information such as executable instructions and/or other data to be selectively stored and retrieved. In the exemplary embodiment, such data may include, but is not limited to, material properties of metallic and composite materials, characteristics of ultrasonic waves, modeling data, imaging data, calibration curves, operational data, and/or control algorithms. In the exemplary embodiment, computer system 200 is configured to automatically implement a parametric finite element analysis to determine a desired evaluation setting for use in inspecting an adhesively bonded joint. Alternatively, computer system 200 may use any algorithm and/or method that enables the methods and systems to function as described herein. Memory device 202 may also include one or more non-transitory tangible computer-readable storage media, such as, without limitation, dynamic random access memory, static random access memory, a solid state disk, and/or a hard disk.

In the exemplary embodiment, computer system 200 further comprises a display interface 206 that is coupled to processor 204 for use in presenting information to a user. For example, display interface 206 may include a display adapter (not shown) that may couple to a display device 208, such as, without limitation, a cathode ray tube, a liquid crystal display, a light-emitting diode (LED) display, an organic LED display, an “electronic ink” display, and/or a printer.

Computer system 200, in the exemplary embodiment, further comprises an input interface 212 for receiving input from the user. For example, in the exemplary embodiment, input interface 212 receives information from an input device 210 suitable for use with the methods described herein. Input interface 212 is coupled to processor 204 and to input device 210, which may include, for example, a joystick, a keyboard, a pointing device, a mouse, a stylus, a touch sensitive panel (e.g., a touch pad or a touch screen), and/or a position detector.

In the exemplary embodiment, computer system 200 further comprises a communication interface 214 that is coupled to processor 204. In the exemplary embodiment, communication interface 214 communicates with at least one remote device, e.g., a transceiver 216. For example, communication interface 214 may use, without limitation, a wired network adapter, a wireless network adapter, and/or a mobile telecommunications adapter. A network (not shown) used to couple computer system 200 to the remote device may include, without limitation, the Internet, a local area network (LAN), a wide area network, a wireless LAN, a mesh network, and/or a virtual private network or other suitable communication means.

In the exemplary embodiment, computer system 200 further comprises at least a modeling module 218, an imaging module 220, and an analysis module 222 that enable at least some of the methods and systems to function as described herein. These modules may take the form of software comprising code executed by the processor 204. In the exemplary embodiment, modeling module 218 is configured to generate finite element models of a hybrid structure comprising an adhesively bonded joint; imaging module 220 is configured to produce and process images such as micrographs and B-scan images; and analysis module 222 is configured to perform a FEM failure analysis of the finite element model by applying boundary conditions and loads.

Finite element analysis is the practice of simulating an object using similarly shaped elements. A finite element model (FEM) is composed of volumetric elements, such as tetrahedra, each having associated parameters and equations of motion. A group of elements and their parameters are used to describe a system of equations to be solved. In the present application, the finite element model may include data indicating the presence of one or more disbond cracks, delaminations, adhesive failures, adhesive degradation, adhesive cracks, cohesive failures, etc. in the adhesively bonded joint.

After the finite element model of the adhesively bonded joint has been generated (step 174), that model is subjected to automated structural analysis, e.g., finite element model analysis 178. For example, the finite element model may be subjected to boundary conditions 180 such as structural information and local geometry and loads of a structural load environment 182 to produce a strain field, which can be analyzed. If the anomalies in the NDI data represent damage of one of the types previously described, the finite element model analysis 178 can be used to determine the residual strength of the adhesively bonded joint.

In some embodiments the output of the finite element model analysis may be compared to or correlated with allowed damage. The allowed damage may be developed using a damage tolerance analysis. The allowable output by the damage tolerance analysis may be input to the finite element model analysis. The comparison could take a variety of forms. For example, a scalar maximum strain value could be calculated from the analysis and compared to a single allowable strain number from a design manual, a design guide, or a table created by previous test results and statistical analysis.

With allowable damage limits established, decisions about the health of the structure can now be made based on the relative magnitude of the ultimate or limit strength of the pre-anomaly structure and the ultimate or limit strength as predicted by the post-anomaly stress analysis. In some embodiments a good/not good decision regarding the continued use of the structure or component may be made as part of the finite element model analysis. As a decision aid, a graphical representation of the acceptability of the structure, and the resulting effect on future use, may be produced and output in some embodiments.

If the results of the finite element model analysis indicate that the predicted health of the adhesively bonded joint is good, e.g., has a strength parameter greater than a pre-set criterion (which is predetermined by allowables/models), such as a minimum allowable strength, the inspection is ended and the part is accepted for use as is. If the results of the finite element model analysis indicate that the predicted health of the simulated adhesively bonded joint is not good, e.g., has a strength parameter less than the pre-set criterion, then a determination is made (as part of the FEM analysis) whether such an adhesively bonded joint would be repairable to function or not.

If the adhesively bonded joint is predicted to be repairable to function, then a similar adhesively bonded joint of an actual hybrid structure is repaired. Upon completion of the repair, the repaired structure may undergo inspection and analysis in the manner previously described.

If the adhesively bonded joint is predicted to be not repairable to function, then the similar adhesively bonded joint of an actual hybrid structure is rejected for use. All inspection, image processing, modeling and analysis data and the performance prediction associated with the rejected part are saved as a function of location within the similar adhesively bonded joint in data storage for use in-service if damage occurs in the future. The data storage is a non-transitory tangible computer-readable storage medium. All adhesively bonded joint data is used for analytic purposes, and fed back into the tool to process changes before sub-rejectable anomalies get worse.

The numerical simulations described above were directed to the use of a structural health monitoring system to assess the quality of adhesive bonds between two materials by measuring the propagation of ultrasonic interface waves through the adhesive, guided by the physical interface between the materials and the adhesive. The interface waves that result from an ultrasonic stimulus of the bonded materials are a mixture of wave effects resulting from differences in velocity, phase, and amplitude, originating from differences in material viscosity, density, thickness, continuity, and specifically differences at the physical boundaries between materials.

One or more the following wave characteristics can be measured to differentiate good bonds from bad bonds: (1) wave velocity (wavefront time of flight over a given distance); (2) wave attenuation (diminishing amplitude over a known distance due to absorption and scattering of the interface wave); and (3) wave energy dissipation (diminishing amplitude integral over a known distance due to absorption and scattering of the interface wave). The results of this study suggest development of a repeatable and reliable inspection method for the assessment of adhesively bonded joints.

While methods for the structural health monitoring of adhesively bonded joints (also referred to herein as “adhesive bondlines”) have been described with reference to various embodiments, it will be understood by those skilled in the art that various changes may be made and equivalents may be substituted for elements thereof without departing from the scope of the teachings herein. In addition, many modifications may be made to adapt the teachings herein to a particular situation without departing from the scope thereof. Therefore it is intended that the claims not be limited to the particular embodiments disclosed herein.

The methods described herein may be encoded as executable instructions embodied in a non-transitory tangible computer-readable storage medium, including, without limitation, a storage device and/or a memory device. Such instructions, when executed by a processing or computing system, cause the system device to perform at least a portion of the methods described herein.

As used in the claims, the term “flag” should be construed broadly to encompass any of the following: an analog signal, a digital code, a report, a notice, an alert or a warning.

The process claims set forth hereinafter should not be construed to require that the steps recited therein be performed in alphabetical order (any alphabetical ordering in the claims is used solely for the purpose of referencing previously recited steps) or in the order in which they are recited unless the claim language explicitly specifies or states conditions indicating a particular order in which some or all of those steps are performed. Nor should the process claims be construed to exclude any portions of two or more steps being performed concurrently or alternatingly unless the claim language explicitly states a condition that precludes such an interpretation.

1. A method for structural health monitoring of an adhesive bondline in a structure, comprising:
simulating a structure comprising first and second simulated substrates joined along a simulated adhesive bondline;
simulating propagation of ultrasonic waves along a portion of the simulated adhesive bondline;
storing reference data in a non-transitory tangible computer-readable storage medium, which reference data represents a wave characteristic of simulated ultrasonic waves that have propagated along the portion of the simulated adhesive bondline and arrived at a sensing location on a surface of the simulated structure;
generating ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondline respectively;
converting ultrasonic waves which have propagated along the portion of the adhesive bondline and arrived at a sensing location on a surface of the actual structure into measurement electrical signals;
processing the measurement electrical signals to derive measurement data representing an empirical wave characteristic;
storing the adhesive bondline data representing the empirical wave characteristic in the non-transitory tangible computer-readable storage medium;
determining a difference between the measurement data and the reference data; and
classifying the adhesive bondline as being damaged or not in dependence on the difference.

2. The method as recited in claim 1, wherein the simulated adhesive bond has no simulated defects, and classifying the adhesive bondline comprises classifying the adhesive bondline as being damaged if the difference is greater than a specified threshold.

3. The method as recited in claim 1, wherein the simulated adhesive bond has at least one simulated defect, and classifying the adhesive bondline comprises classifying the adhesive bondline as being damaged if the difference is less than a specified threshold.

4. The method as recited in claim 1, wherein the first substrate is a metallic substrate and the second substrate is a composite laminate.

5. The method as recited in claim 1, wherein the wave characteristic is time of travel of the ultrasonic waves as the ultrasonic waves propagated along the portion of the adhesive bondline.

6. The method as recited in claim 1, wherein the wave characteristic is change in amplitude of the ultrasonic waves as the ultrasonic waves propagated along the portion of the adhesive bondline.

7. The method as recited in claim 1, wherein the wave characteristic is change in phase of the ultrasonic waves as the ultrasonic waves propagated along the portion of the adhesive bondline.

8. The method as recited in claim 1, wherein the wave characteristic is change in wave energy distribution of the ultrasonic waves as the ultrasonic waves propagated along the portion of the adhesive bondline.

9. The method as recited in claim 1, further comprising generating a flag in response to the adhesive bondline being classified as damaged.

10. The method as recited in claim 9, further comprising repairing or replacing the damaged adhesive bondline.

11. The method as recited in claim 1, wherein the simulated adhesive bondline of the simulated structure and the adhesive bondline of the actual structure have the same thickness.

12. The method as recited in claim 1, wherein the sensing location on the surface of the simulated structure and the sensing location on the surface of the actual structure are the same.

13. The method as recited in claim 12, further comprising:
simulating generation of ultrasonic waves at a generating location on the surface of the simulated structure; and
generating ultrasonic waves at a generating location on the surface of the actual structure,
wherein the generating location on the surface of the simulated structure and the generating location on the surface of the actual structure are the same.

14. A method for structural health monitoring of an adhesive bondline, comprising:
simulating a structure comprising first and second simulated substrates joined along a simulated undamaged adhesive bondline free of defects;
simulating propagation of ultrasonic waves along a portion of the simulated undamaged adhesive bondline free of defects;
simulating respective structures comprising the first and second simulated substrates joined along respective simulated damaged adhesive bondlines having respective defects of different lengths, wherein the undamaged adhesive bondline and the damaged adhesive bondlines have the same material properties and the same thickness;
simulating propagation of ultrasonic waves along a portion of each simulated damaged adhesive bondline;
storing reference data in a non-transitory tangible computer-readable storage medium, which reference data represents wave characteristics of simulated ultrasonic waves that have propagated along the respective portions of the undamaged and simulated damaged adhesive bondlines and arrived at a sensing location on a surface of the simulated structure;
generating ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondlines respectively;
converting ultrasonic waves which have propagated along the portion of the adhesive bondline and arrived at a sensing location on a surface of the actual structure into measurement electrical signals;
processing the measurement electrical signals to derive measurement data representing an empirical wave characteristic;
storing the measurement data representing the empirical wave characteristic in the non-transitory tangible computer-readable storage medium;
comparing the measurement data to the reference data; and
classifying the adhesive bondline as being damaged or not in dependence on the results of comparing the measurement data to the reference data.

15. The method as recited in claim 14, wherein the first substrate is a metallic substrate and the second substrate is a composite laminate.

16. The method as recited in claim 14, further comprising generating a flag in response to the adhesive bondline being classified as damaged.

17. The method as recited in claim 16, further comprising repairing or replacing the damaged adhesive bondline.

18. A structural health monitoring system comprising:
a wave generator, a pulser configured to send pulses to the wave generator, a wave sensor, a receiver configured to receive electrical signals from the wave sensor, and a computing system configured with simulation software, system control software for controlling the pulser and receiver, signal analysis software for analyzing signals output by the receiver, and a non-transitory tangible computer-readable storage medium;
wherein the simulation software is configured to enable the computing system to perform the following operations:
simulating a structure comprising first and second simulated substrates joined along a simulated undamaged adhesive bondline free of defects;
simulating propagation of ultrasonic waves along a portion of the simulated undamaged adhesive bondline free of defects;
simulating respective structures comprising the first and second simulated substrates joined along respective simulated damaged adhesive bondlines having respective defects of different lengths, wherein the undamaged adhesive bondline and the damaged adhesive bondlines have the same material properties and the same thickness;
simulating propagation of ultrasonic waves along a portion of each simulated damaged adhesive bondline; and
storing reference data in the non-transitory tangible computer-readable storage medium, which reference data represents wave characteristics of simulated ultrasonic waves that have propagated along the respective portions of the undamaged and simulated damaged adhesive bondlines and arrived at a sensing location on a surface of the simulated structure;
wherein the system control software is configured to enable the computing system to perform the following operations:
causing the wave generator to generate ultrasonic waves which propagate along a portion of an adhesive bondline that joins first and second substrates of an actual structure, wherein the first and second substrates and the adhesive bondline have material properties which are the same as or similar to material properties of the first and second simulated substrates and simulated adhesive bondlines respectively; and
causing the wave sensor to convert ultrasonic waves which have propagated along the portion of the adhesive bondline and arrived at a sensing location on a surface of the actual structure into measurement electrical signals;
wherein the signal analysis software is configured to enable the computing system to perform the following operations:
processing the measurement electrical signals to derive measurement data representing an empirical wave characteristic; and
storing measurement data representing the empirical wave characteristic in the non-transitory tangible computer-readable storage medium; and
wherein the system control software is further configured to enable the computing system to perform the following operations:
comparing the measurement data to the reference data; and
classifying the adhesive bondline as being damaged or not in dependence on the results of comparing the measurement data to the reference data.

19. The system as recited in claim 18, wherein the system control software is further configured to enable the computing system to generate a flag in response to the adhesive bondline being classified as damaged.

20. The system as recited in claim 18, wherein the empirical wave characteristic is selected from the following group: wave velocity, wavefront time of flight over a given distance, wave attenuation and wave energy dissipation.
